(19) United States
(12) Patent Application Publication
(10) Pub. No.: US 2015/0363867 A1
(43) Pub. Date: Dec. 17, 2015

(54) Purchase Optimization Service

(71) Applicant: AT&T Mobility II LLC, Atlanta, GA (US)

(72) Inventors: Rick Tipton, Corryton, TN (US); Jeremy Fix, Acworth, GA (US); Sheldon Kent Meredith, Roswell, GA (US)

(73) Assignee: AT&T MOBILITY II LLC, Atlanta, GA (US)

(21) Appl. No.: 14/306,491

(22) Filed: Jun. 17, 2014

(51) Int. Cl. G06Q 30/06

(52) U.S. Cl. CPC G06Q 30/0633

(57) ABSTRACT

Concepts and technologies are disclosed herein for purchase optimization service. A processor can execute a purchasing optimization service. Service preferences for purchasing using the purchasing optimization service can be defined. A purchase request that includes a request to purchase an item using the purchase optimization service can be received. Purchase preferences specific to the purchase request can be defined, and two or more purchase options determined based upon the service preferences, the purchase preferences, and the purchase request can be determined. A purchase option from the two or more purchase options can be determined, and the item can be purchased using the purchase option.

### BACKGROUND

Because of advances in communications and other technologies, consumers sometimes use online purchasing sites or services to purchase or schedule purchasing of products. Generally speaking, online purchasing sites are operated by particular vendors such as stores, marketplaces, online-only vendors, or the like. A consumer can access a website associated with the vendor to determine various aspects of the vendor's offering of the product, and purchase the product from the vendor, if desired. Because some products may be offered by a large number of vendors, a consumer rarely knows if he or she has found the best deal available for purchasing the product.

Some vendors support subscription services for purchases. Thus, a consumer may create a subscription to automatically purchase and receive products on a particular schedule without being required to access the vendor site to create a new order. Subscriptions are useful in urging users to repeatedly purchase goods from a particular vendor, as the purchase is automatic. One drawback to subscriptions, however, is that vendors may change prices over time, availability of the products at the vendor (where the subscription exists) may change over time, and/or other aspects of the vendor's offerings may change. Thus, users may not receive the desired products in accordance with a subscription schedule, or alternatively may not receive the best deal available on a particular instance of a purchase associated with the subscription.

### SUMMARY

The present disclosure is directed to a purchase optimization service. The purchase optimization service can correspond to an application or service hosted and/or executed by a computing device such as a server computer. The purchase optimization service can be called by devices, users, or processes to optimize a purchase based upon various criteria. The criteria can include global settings and/or purchase-specific settings. The purchase optimization service also can support subscriptions, wherein the purchase optimization service can optimize the purchase each time a purchase is made in accordance with a subscription, as opposed to merely creating a subscription with a particular vendor or service. As such, the purchase optimization service can obtain an optimal price and delivery schedule for each purchase.

According to various embodiments, the purchase optimization service can receive a purchase request. The purchase request can be generated by a device via an application, web interface, or the like. The purchase request also can be generated by a device such as a smart appliance. The purchase request also can be generated as part of a subscription, for example upon expiration of a time interval, or the like. The purchase request can relate to a particular item. Although called a “purchase request” herein, the functionality described herein for optimizing purchases also can be used to determine optimal offerings outside of an actual purchase request. As used herein, an “item” can refer to a good or service.

The purchase optimization service can use information included in or with the purchase request to identify purchase options to purchase an item identified in the purchase request. Various options, settings, and/or rankings of these settings or options can be taken into account by the purchase optimization service when ranking the purchase options. The purchase optimization service can provide the purchase options to a requestor or other entity and obtain, from the requestor or other entity a desired purchase option or an option to cancel the purchase. Successful and unsuccessful (e.g., cancelled) purchases can be added to a report by the purchase optimization service, if desired, and provided to a requestor or other entity.

If a purchase option is received by the purchase optimization service, the purchase optimization service can access billing data associated with the requestor such as account information for a service provider, or the like. The purchase optimization service can validate the billing data and complete the purchase using the billing data. Thus, the purchase optimization service can optimize each purchase made using the purchase optimization service, as well as simplify payment processes for users of the purchase optimization service. These and other aspects of the concepts and technologies described herein will be explained in more detail herein.

According to one aspect of the concepts and technologies disclosed herein, a method is disclosed. The method can include defining, at a processor executing a purchasing optimization service, service preferences for purchasing using the purchasing optimization service. The service preferences can apply to purchases made using the purchasing optimization service. The method also can include receiving, at the processor, a purchase request including a request to purchase an item using the purchase optimization service. The processor can determine purchase preferences specific to the purchase request, and generate two or more purchase options determined based upon the service preferences, the purchase preferences, and the purchase request. The method also can include determining, at the processor, a purchase option of the plurality of purchase options, and purchasing, by the processor, the item using the purchase option.

In some embodiments, determining the purchase option can include providing two or more purchase options to a requestor associated with the purchase request and receiving, from the requestor, identification of the purchase request. Determining the two or more purchase options can include identifying two or more vendors, identifying, for each of the two or more vendors, a total cost and time to delivery for the item, and determining each of the two or more purchase options. Each of the two or more purchase options can identify a vendor, the total cost, and the time to delivery. In some embodiments, determining the total cost can include identifying a coupon available and applying a coupon, and in some embodiments, determining the total cost can include determining shipping costs and identifying tax due for the purchase. Determining the time to delivery can include identifying a processing time for the vendor and determining a shipping time for the item.

In some embodiments, the method can include creating a subscription for the item. The optimization service can determine the purchase option each time a purchase is made in accordance with the subscription. The method also can include generating a report. The report can include indications of purchases made using the purchasing optimization service. In some embodiments, the service preferences can include options for setting ratings for total price for the item, shipping cost, shipping time, and availability of coupons.

In some embodiments, the purchase preferences can include options for indicating whether buying the item used is allowed, whether particular vendors are to be considered, and whether a subscription for the purchase is to be created. In some embodiments, receiving the purchase request can include determining that a reorder process associated with a subscription is to be initiated. In some embodiments, receiving the purchase request can include receiving the request from a smart appliance that determines that the item should be reordered. In some embodiments, the item can include a service. In some embodiments, the method also can include ranking the two or more purchase options based upon the purchase request, the service preferences, and the purchase preferences.

According to another aspect of the concepts and technologies disclosed herein, a system is disclosed. The system can include a processor and a memory. The memory can store computer-executable instructions that, when executed by the processor, cause the processor to perform operations. The operations can include defining service preferences for purchasing using a purchasing optimization service. The service preferences can apply to purchases made using the purchasing optimization service. The operations also can include receiving a purchase request including a request to purchase an item using the purchase optimization service, defining purchase preferences specific to the purchase request, generating two or more purchase options determined based upon the service preferences, the purchase preferences, and the purchase request, determining a purchase option of the two or more purchase options, and purchasing the item using the purchase option.

In some embodiments, the system can include computer-executable instructions that, when executed by the processor, cause the processor to perform operations that include ranking the two or more purchase options based upon the purchase request, the service preferences, and the purchase preferences. In some embodiments, ranking the two or more purchase options can include identifying, for each of the two or more purchase options, a total cost and time to delivery for the item, and ranking the two or more purchase options based upon comparing the total cost and time to delivery to the service preferences and purchase preferences.

In some embodiments, determining the total cost can include identifying a coupon available and applying the coupon to a price for the item, subtracting a value of the coupon from the price for the item, determining shipping costs and tax due for the purchase, and adding the shipping cost and tax due to the price for the item. In some embodiments, the system can include computer-executable instructions that, when executed by the processor, cause the processor to perform operations that further include creating a subscription for the item. The optimization service can determine the purchase option each time a purchase is made in accordance with the subscription.

According to yet another aspect, a computer storage medium is disclosed. The computer storage medium can have computer-executable instructions stored thereon that, when executed by a processor, cause the processor to perform operations. The operations can include defining service preferences for purchasing using a purchasing optimization service. The service preferences can apply to purchases made using the purchasing optimization service. The operations further can include receiving a purchase request including a request to purchase an item using the purchase optimization service, defining purchase preferences specific to the purchase request, generating two or more purchase options determined based upon the service preferences, the purchase preferences, and the purchase request, determining a purchase option of the two or more purchase options, and purchasing the item using the purchase option.

In some embodiments, the computer storage medium can include computer-executable instructions that, when executed by the processor, cause the processor to perform operations further including ranking the two or more purchase options based upon the purchase request, the service preferences, and the purchase preferences. Ranking the two or more purchase options can include identifying, for each of the two or more purchase options, a total cost and time to delivery for the item, and ranking the two or more purchase options based upon comparing the total cost and time to delivery to the service preferences and purchase preferences. The operations further can include creating a subscription for the item. In some embodiments, the optimization service can determine the purchase option each time a purchase is made in accordance with the subscription.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a system diagram illustrating an illustrative operating environment for the various embodiments disclosed herein.

FIG. 2 is a flow diagram showing aspects of a method for attempting a purchase using a purchase optimization service, according to an illustrative embodiment.

FIG. 3 is a flow diagram showing aspects of a method for calculating and ranking purchase options using a purchase optimization service, according to an illustrative embodiment.

FIGS. 4A-4E are user interface diagrams showing illustrative screen displays for configuring, interacting with, and using a purchase optimization service, according to some illustrative embodiments.

FIG. 5 schematically illustrates a network, according to an illustrative embodiment.

FIG. 6 is a block diagram illustrating an example computer system configured to provide a purchase optimization service, according to some illustrative embodiments.

FIG. 7 is a block diagram illustrating an example mobile device configured to interact with a purchase optimization service, according to some illustrative embodiments.

### DETAILED DESCRIPTION

The following detailed description is directed to a purchase optimization service. The purchase optimization service can receive a purchase request. The purchase request can be generated by a computing device based upon interactions with the computing device, by a device such as a smart appliance based upon detecting a need or desire for the purchase, and/or as part of a subscription or reorder policy. The purchase request also can correspond to a request to generate purchase options, without actually desiring to purchase an item. The purchase optimization service can use information included in or with the purchase request to identify purchase options to purchase a good or service identified in the purchase request.

Various options, settings, and/or rankings of these settings or options can be taken into account by the purchase optimization service when ranking the purchase options. The purchase optimization service can provide the purchase options to a requestor or other entity and obtain, from the requestor or other entity, a desired purchase option. The purchase optimization service can access billing data associated with the requestor such as account information for a service provider, or the like, validate the billing data, and complete the purchase using the billing data. Successful and unsuccessful purchase attempts can be added to a report by the purchase optimization service, if desired, and provided to a requestor or other entity. Additionally, if the functionality of the purchasing optimization service is invoked merely to determine purchase options (without making a purchase), the purchase options can be added to one or more reports.

Thus, embodiments of the purchase optimization service disclosed herein can optimize each purchase made using the purchase optimization service, as well as simplify payment processes for users of the purchase optimization service. These and other aspects of the concepts and technologies described herein will be explained in more detail herein.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

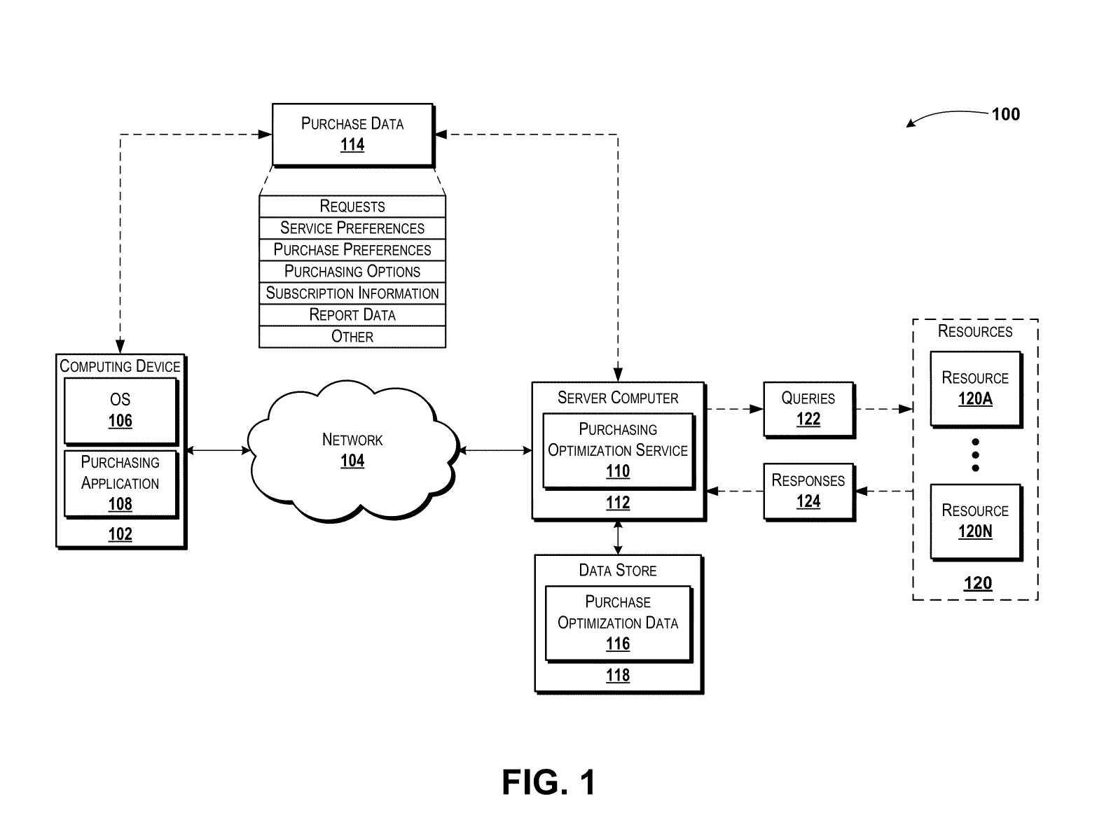

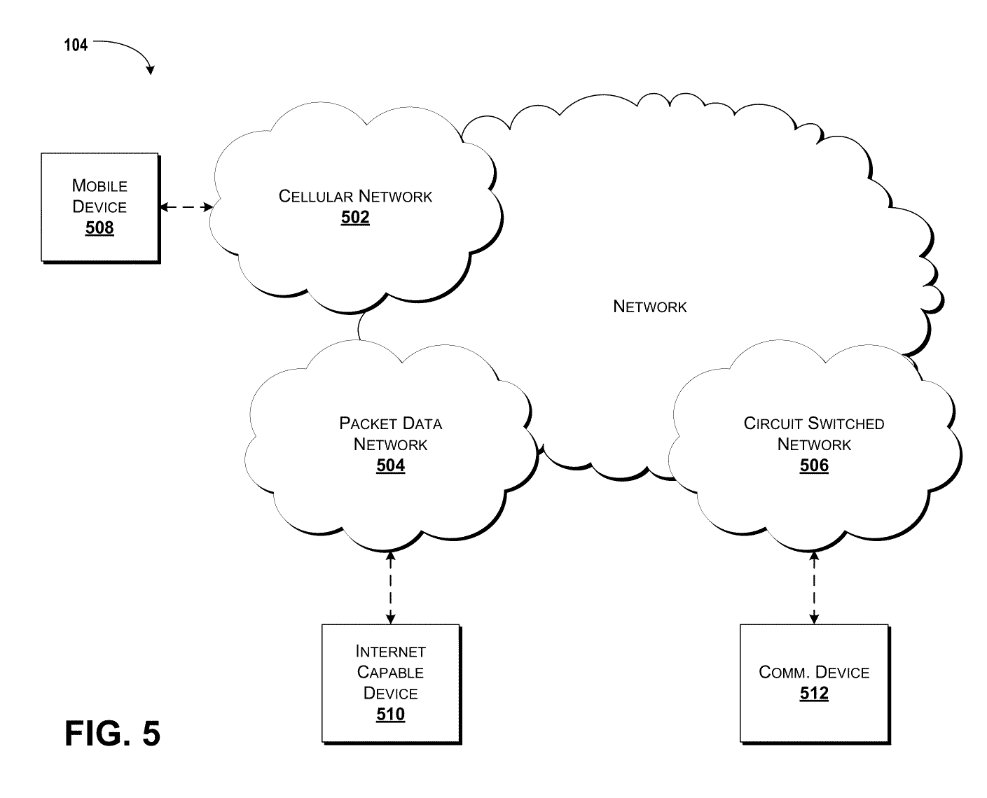

Referring now to FIG. 1, aspects of an operating environment 100 for various embodiments of the concepts and technologies disclosed herein for a purchase optimization service will be described, according to an illustrative embodiment. The operating environment 100 shown in FIG. 1 includes a computing device 102. According to various embodiments, the computing device 102 can operate in communication with and/or as part of a communications network (“network”) 104, though this is not necessarily the case. Various embodiments of the network 104 will be illustrated and described in more detail below, particularly with reference to FIG. 5.

According to various embodiments, the functionality of the computing device 102 may be provided by one or more server computers; desktop computers; mobile telephones; smartphones; portable media devices such as a member of the iPod family of devices from Apple Corporation in Cupertino, Calif.; laptop computers; tablet or slate computers; set-top boxes (“STBs”) or set-top units (“STUs”); embedded control systems or inventory systems of smart appliances or other devices; other computing systems; and the like. It should be understood that the functionality of the computing device 102 can be provided by a single device, by two similar devices, and/or by two or more dissimilar devices. For purposes of describing the concepts and technologies disclosed herein, the computing device 102 is described herein as a smartphone, smart appliance, or computer (PC, laptop, or tablet). It should be understood that this embodiment is illustrative, and should not be construed as being limiting in any way.

The computing device 102 can execute an operating system 106 and one or more application programs such as, for example, a purchasing application 108. The operating system 106 is a computer program for controlling the operation of the computing device 102. The purchasing application 108 can include an executable program configured to execute on top of the operating system 106 to provide various functionality described herein for optimizing purchases and/or interacting with services or applications for optimizing purchases.

According to various embodiments, the functionality of the purchasing application 108 can be provided by a web browser that interacts with a service or application that can be hosted, for example, by a web server or the like. In some other embodiments, the functionality of the purchasing application 108 can be provided by a stand-alone or natively executed application or web application (“web app”) that can download data from various sources to provide the functionality illustrated and described herein.

For purposes of illustrating and describing various embodiments of the concepts and technologies described herein, the purchasing application 108 will be described as an application that interacts with and/or downloads information from a purchasing optimization service 110 to provide the functionality described herein for optimizing purchases. The purchasing optimization service 110 can be hosted and/or executed by a computing device such as a server computer 112. Because the purchasing optimization service 110 can interact with other devices and/or applications, and because the purchasing application 108 can provide the functionality illustrated and described herein in additional and/or alternative ways, it should be understood that this example is illustrative and therefore should not be construed as being limiting in any way.

The purchasing application 108 can be configured to exchange purchase data 114 with the purchasing optimization service 110. The functionality of the purchasing optimization service 110 for generating and/or using the purchase data 114 will be illustrated and described in more detail below. Briefly, the purchase data 114 can include requests such as purchase requests and/or service calls for requesting purchase optimization functionality from the purchasing optimization service 110; service preferences such as global payment, billing, invoicing, shipping, ordering, vendor, payment, and/or other preferences; purchase preferences such as payment, billing, invoicing, shipping, ordering, vendor, payment, and/or other preferences that can be tailored for a particular purchase or subscription; purchasing options that can define a vendor, cost, shipping time, and/or other purchase variables for presentation and/or selection by a user or other entity associated the computing device 102; subscription information such as data defining subscription intervals, effective dates, overrides, delays, or the like; report data that can define format and/or content of reports for conveying purchase histories, subscription histories, successful and/or unsuccessful purchase attempts, or the like; and/or other information or data. Because the purchase data 114 can include additional and/or alternative data or information, it should be understood that these examples of the purchase data 114 are illustrative and therefore should not be construed as being limiting in any way.

The purchase data 114 can be generated by the purchasing application 108 and/or the purchasing optimization service 110, as will be explained in more detail below. In particular, the purchase data 114 can be generated by the purchasing application 108 and/or generated by the purchasing optimization service 110 via interactions between the computing device 102 and the server computer 112. Thus, the purchasing optimization service 110 can receive a request or service call, preferences, options, or the like, in some embodiments. In some other embodiments, these and other types of purchase data 114 can effectively be generated by the purchasing optimization service 110 via interactions between the computing device 102 or other device and the server computer 112.

The purchasing optimization service 110 can receive a request or service call (hereinafter referred to as a “request”), and identify one or more products or services associated with the request. The purchasing optimization service 110 also can be configured to obtain or receive service preferences, purchase preferences, and/or other information associated with the request. In some embodiments, the purchasing optimization service 110 receives a request from the computing device 102, and responds by requesting the preferences and/or options from the computing device 102. In some other embodiments, the purchasing optimization service 110 can be configured to store service preferences, purchase preferences, purchasing options, subscription information, and/or other information or data as purchase optimization data 116.

The purchasing optimization service 110 can be configured to store the purchase optimization data 116 at a local memory or other data storage device, in some embodiments. In some other embodiments, the purchasing optimization service 110 can be configured to store the purchase optimization data 116 at a remote data storage location or device such as, for example, a data store 118, or the like. According to various embodiments, the purchase optimization data 116 can be stored with data or other information that associates the purchase optimization data 116 with a user, account, device, or the like.

The purchase optimization data 116 can be stored in a table, database, or other data structure that can support querying and/or other lookup operations. As such, the purchase optimization data 116 can be searched or queried according to various aspects of the purchase optimization data 116, and the purchasing optimization service 110 can identify relevant purchase optimization data 116 based upon various aspects of the purchase data 114 including, but not limited to, a user, device, item, account, subscription, and/or other aspect of the request or related information, or the like. Because the purchase optimization data 116 can be queried or searched based upon other information and/or considerations, it should be understood that these examples are illustrative and therefore should not be construed as being limiting in any way.

The purchasing optimization service 110 can receive the purchase data 114 such as a request. Based upon information included in the request such as, for example, a product, service, vendor, or other information, the purchasing optimization service 110 can identify one or more resources 120A-N (hereinafter collectively and/or generically referred to as “resources 120”) to interact with to satisfy the request. The resources 120 can include, but are not limited to, shopping sites and/or services, coupon sites and/or services, electronic marketplaces, shopping discount sites and/or services, auctions sites and/or services, deal sites and/or services, combinations thereof, or the like. For example, if the request corresponds to a request to purchase a computer, the purchasing optimization service 110 can identify one or more resources 120, wherein the resources 120 can include, for example, computer sales sites or services, computer coupon sites or services, or the like. It should be understood that this example is illustrative and therefore should not be construed as being limiting in any way.

The purchasing optimization service 110 can generate one or more queries 122, and transmit or submit the queries 122 to the one or more resources 120. The queries 122 can include, for example, requests for information identifying a cost of a product or service; a shipping cost for delivery of a product; a processing time for processing, shipping, and delivering a product and/or a processing and/or delivery time for delivering a service; ratings and/or reviews of products, services, and/or vendors; availability and/or backorder information; other information; combinations thereof; or the like. Although a single instance of the queries 122 is shown in FIG. 1, it should be understood that multiple queries 122 and/or multiple sets of queries 122 can be generated by the purchasing optimization service 110 and/or submitted or transmitted to multiple resources 120 and/or multiple sets of resources 120 by the purchasing optimization service 110.

In response to the queries 122, the purchasing optimization service 110 can receive one or more responses 124 from the resources 120. The responses 124 can include, for example, responses to the example queries 122 listed above. Thus, for example, the responses 124 can include a cost of a product or service; a shipping cost for a product; a processing, shipping, and/or delivery time a product or service; ratings and/or reviews of products, services, and/or vendors; availability and/or backorder information; other information; combinations thereof; or the like. Although a single instance of the responses 124 is shown in FIG. 1, it can be appreciated that multiple responses 124 can be received by the purchasing optimization service 110 from one or more resources 120 and/or multiple sets of resources 120.

The purchasing optimization service 110 can use the responses 124 from the resources 120 to generate one or more purchase options. In particular, the purchasing optimization service 110 can use the information obtained from the resources 120, for example the responses 124, to identify vendors that have available for purchase the requested good or service; costs associated with the vendor providing the good or service (product or service cost, shipping costs, membership or account creation costs, tax or duty costs, etc.); delivery times associated with the vendor delivering the good or service (processing time, shipping time, and/or other times); reviews and/or rankings associated with the vendor, the good, or the service; combinations thereof; or the like. Thus, the purchasing optimization service 110 can determine details associated with purchasing the product or service from the vendor and additional information relating to the purchase so the requestor can determine an anticipated experience if the purchase is made with that particular vendor (time, cost, reviews, etc.).

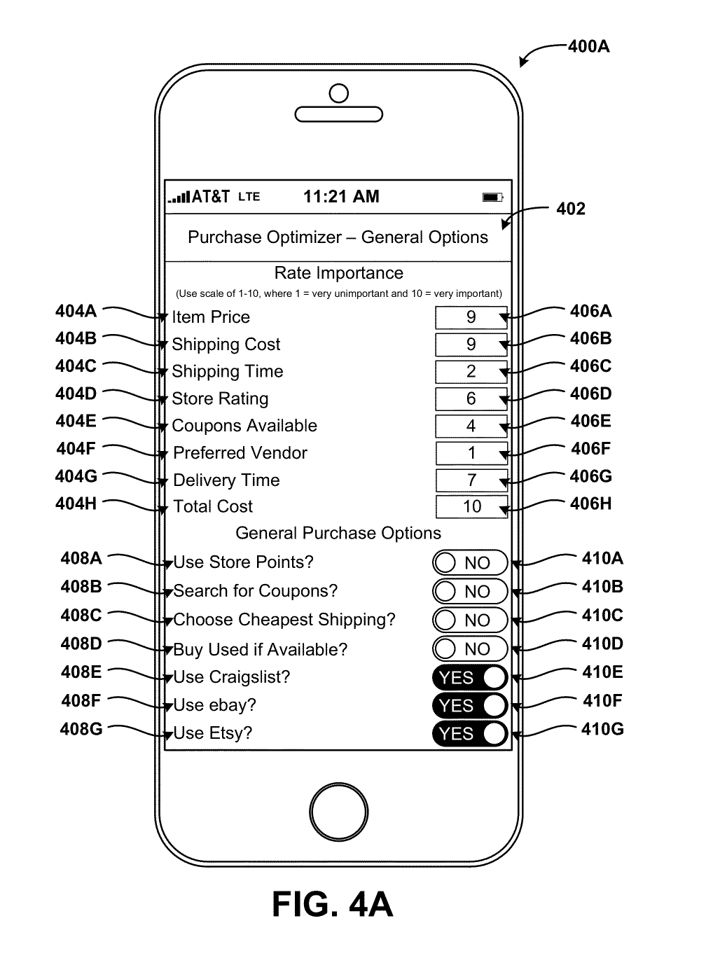

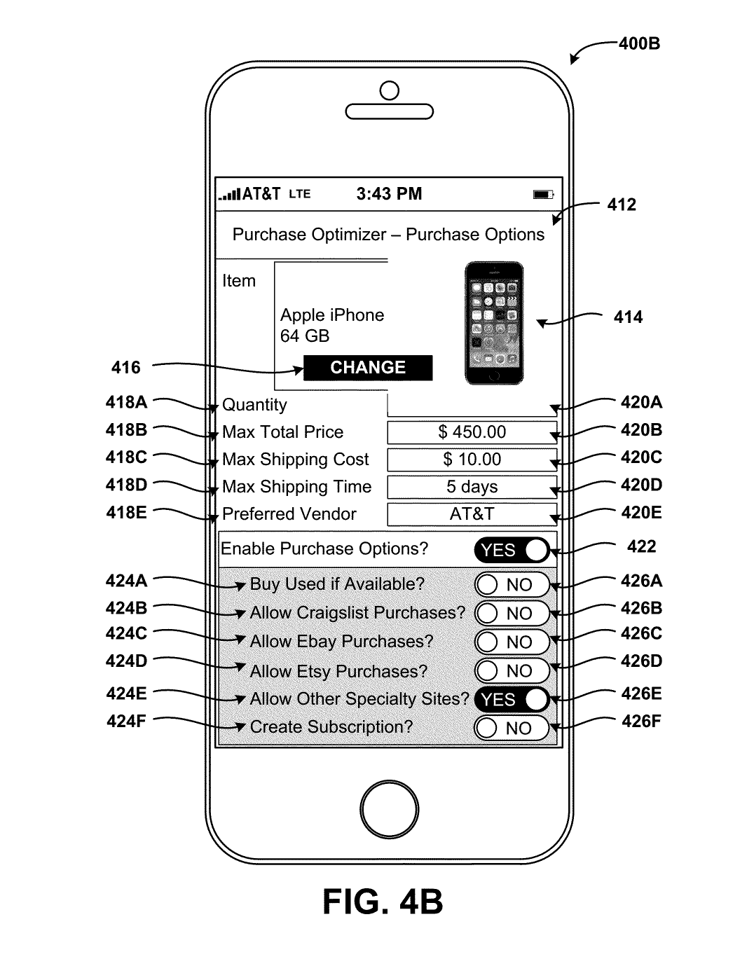

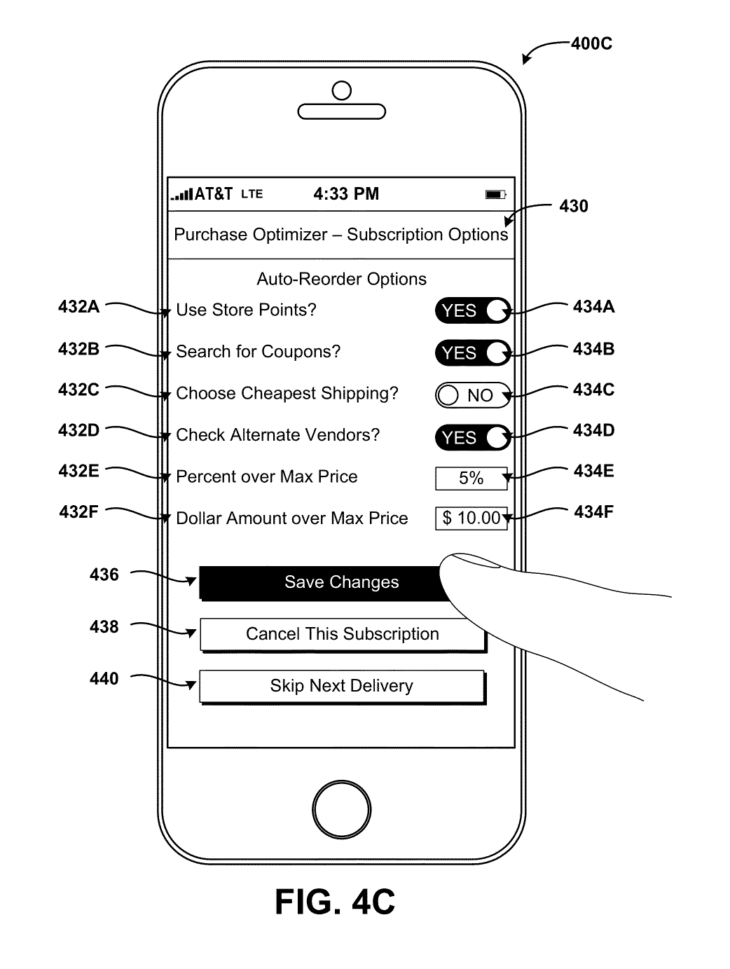

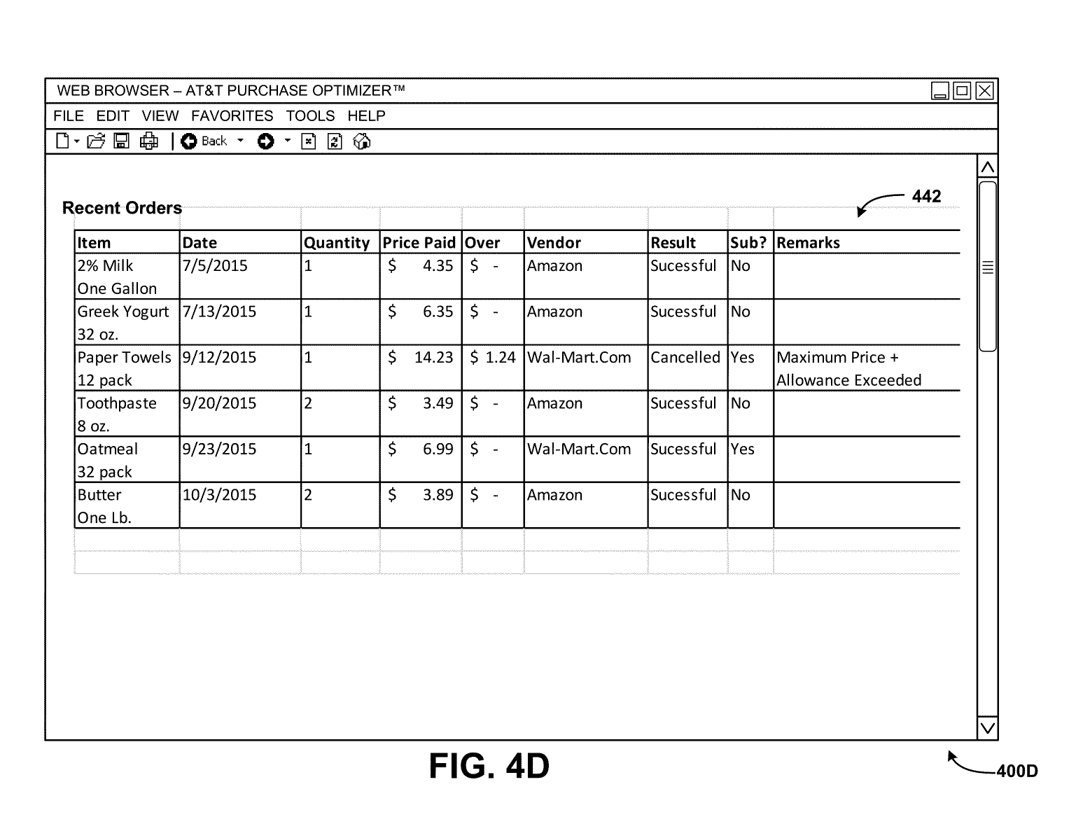

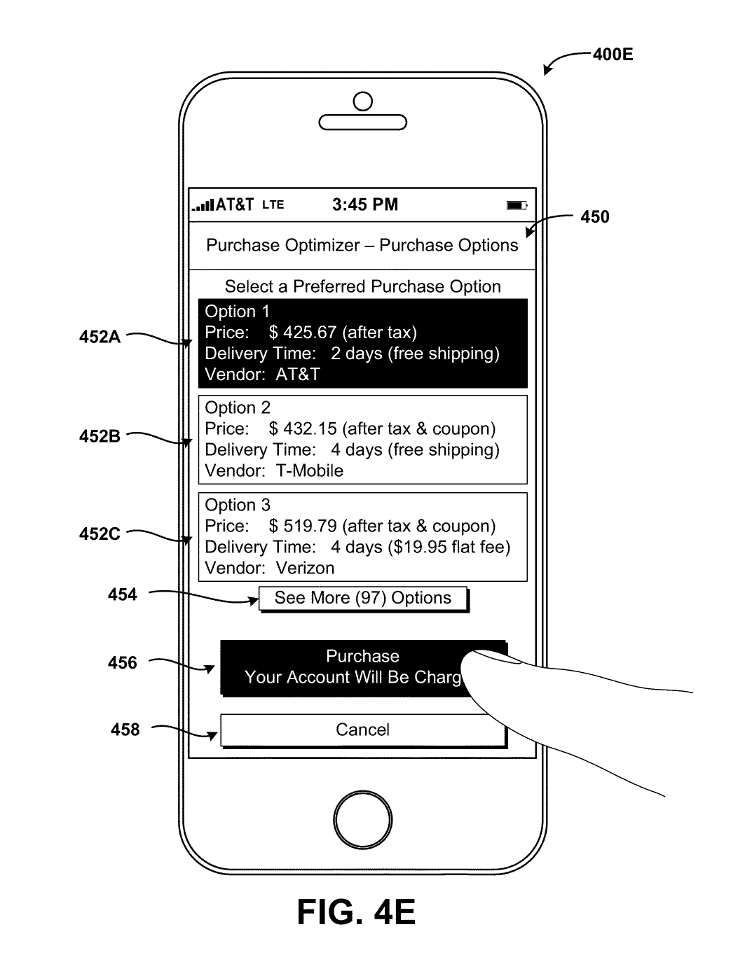

The purchasing optimization service 110 also can be configured to rank the purchase options based upon one or more parameters. Some of the example parameters that may be used, as well as an example embodiment for defining weights and/or ranks for the example parameters, will be illustrated and described below with reference to FIG. 4A. The purchasing optimization service 110 can rank the purchase options based upon various options, preferences, and/or other considerations, and generate a report, a user interface, and/or other representation for providing the purchase options to the requestor.

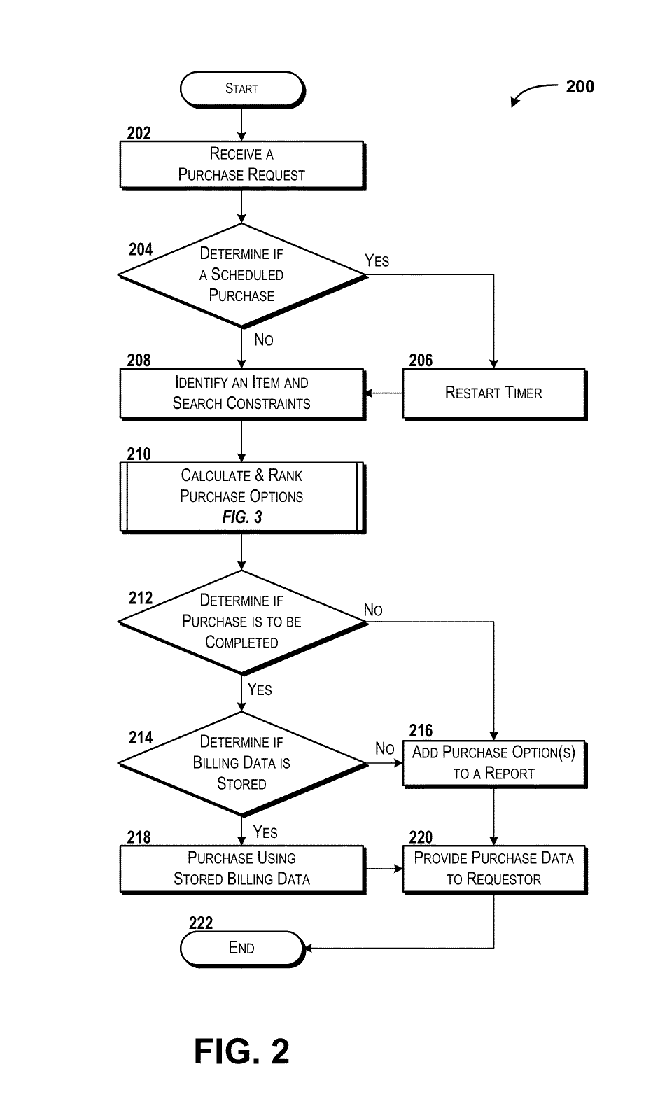

In some embodiments, the report or user interface can be provided to a requestor for informational purposes only. In some other embodiments, the report or user interface can be provided to the requestor to allow selection of a desired purchase option. In some embodiments, the purchase options can be provided to a requestor, and the purchasing optimization service 110 can receive selection of an option to purchase the goods or services using a particular purchase option, an option to cancel the purchase request, or other input from the requestor. These and other aspects of generating and presenting purchase options, as well as receiving input indicating a purchase option that is to be used for a particular purchase will be illustrated and described in more detail below, particular with reference to FIGS. 2-4E.

The purchasing optimization service 110 also can be configured to complete purchases. In various embodiments, the purchasing optimization service 110 can store or access billing data associated with a requestor. For example, the purchasing optimization service 110 can access account information for a wireless service, a telephone service, a television service, an Internet service, a utility service, and/or other accounts, which can be stored by and/or accessible to the purchasing optimization service 110. If billing data is stored or accessible, and in some embodiments if the billing data is valid, the purchasing optimization service 110 can complete the purchase using one or more accounts. If the billing data is not stored, inaccessible, invalid, or otherwise not available, the purchasing optimization service 110 can obtain payment information from the requestor or cancel the purchase. In either event, the purchasing optimization service 110 can output a report or other information indicating the successful and/or unsuccessful purchase.

The purchasing optimization service 110 can bill or charge for successful and/or unsuccessful purchases, if desired. The purchasing optimization service 110 also can be configured to bill or charge for a report showing purchase options, in some embodiments. The purchasing optimization service 110 also can be configured to create and maintain purchase subscriptions, if desired. These and other aspects of the purchasing optimization service 110 and other aspects of the concepts and technologies described herein will be illustrated and described in detail below.

FIG. 1 illustrates one computing device 102, one network 104, one server computer 112, one data store 118, and two resources 120. It should be understood, however, that various implementations of the operating environment 100 include zero, one, or more than one computing device 102, zero, one, or more than one network 104, zero, one, or more than one server computer 112, zero, one, or more than one data store 118, and zero, one, two, or more than two resources 120. As such, the illustrated embodiment should be understood as being illustrative, and should not be construed as being limiting in any way.

Turning now to FIG. 2, aspects of a method 200 for attempting a purchase using a purchase optimization service 110 will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as, the computing device 102 or the server computer 112 to perform one or more operations and/or causing the processor to direct other components of the computing system or device to perform one or more of the operations.

For purposes of illustrating and describing the concepts of the present disclosure, the methods disclosed herein are described as being performed by the server computer 112 via execution of one or more software modules such as, for example, the purchasing optimization service 110. It should be understood that additional and/or alternative devices and/or network nodes can provide the functionality described herein via execution of one or more modules, applications, and/or other software including, but not limited to, the purchasing optimization service 110. Thus, the illustrated embodiments are illustrative, and should not be viewed as being limiting in any way.

The method 200 begins at operation 202. At operation 202, the server computer 112 receives a purchase request. According to various embodiments, the server computer 112 can receive the purchase request in various different ways and/or from various entities. In some embodiments, for example, the purchase request can be received from a device such as the computing device 102. Thus, for example, a user or other entity can generate a purchase request using a web browser, a standalone application, a shopping application, a web application, a service call, combinations thereof, or the like. Thus, for example, a user or other entity may select an option to purchase a good or service, and the purchase request can correspond to such as request. As noted above, the “purchase request” also can effectively be a “report request,” meaning that an actual purchase is not desired. Rather, the request can correspond to a request for ranked purchase options, which can be used for various purposes. It should be understood that this example is illustrative and therefore should not be construed as being limiting in any way.

In some other embodiments, the purchase request received in operation 202 can be received from a computing device 102, wherein the computing device 102 can correspond to an embedded computing system or inventory system. Thus, for example, a smart appliance such as a smart refrigerator or the like can generate an order for a particular product when the product is consumed, according to a schedule, based upon a user command, combinations thereof, or the like. It should be understood that this example is illustrative and therefore should not be construed as being limiting in any way.

In still other embodiments, the purchase request can be generated by and/or prompted by timers or timer jobs, for example, as part of a subscription or automatic reorder policy. Thus, a user or other entity can create a subscription, and the purchasing optimization service 110 can be configured to maintain a timer job or other timing mechanism to prompt reorders according to one or more timeframes associated with the subscription or reorder policy. Because subscriptions can be managed by other devices instead of, or in addition to, the purchasing optimization service 110, it should be understood that this example is illustrative and therefore should not be construed as being limiting in any way.

From operation 202, the method 200 proceeds to operation 204. At operation 204, the server computer 112 determines if the purchase request received in operation 202 corresponds to a scheduled purchase. As explained above, the purchase received in operation 202 can be generated as part of a subscription or automatic reorder policy. Thus, the determination illustrated in operation 204 can correspond to the server computer 112 determining if the purchase request corresponds to a subscription reorder, or the like.

According to various embodiments, the server computer 112 can access user settings and/or a user account to determine if a subscription exists and/or if the purchase request generated in operation 202 corresponds to the subscription. In some other embodiments, the purchase request can include subscription information, of the like, for indicating that the purchase request is associated with a subscription. Because the server computer 112 can determine that the purchase request is associated with a subscription in additional and/or alternative ways, it should be understood that these examples are illustrative and therefore should not be construed as being limiting in any way.

If the server computer 112 determines, in operation 204, that the request received in operation 202 corresponds to a scheduled purchase, the method 200 can proceed to operation 206. In operation 206, the server computer 112 can restart a timer or timer job associated with the scheduled purchase. Thus, for example, if the request received in operation 202 corresponds to a monthly request for a purchase of a particular good or service, operation 206 can correspond to the server computer 112 restarting a timer for one month. It should be understood that in some embodiments, the timer job or timer may not be restarted until after a successful purchase process, and as such, the illustrated embodiment should be understood as being illustrative of one contemplated embodiment and should not be construed as being limiting in any way.

If the server computer 112 determines, in operation 204, that the request received in operation 202 does not correspond to a scheduled purchase, the method 200 can proceed to operation 208. The method 200 also can proceed to operation 208 from operation 206. At operation 208, the server computer 112 can identify an item and search constraints associated with the request received in operation 202.

According to various embodiments, as explained above with reference to FIG. 1, the purchase request illustrated at operation 202 can be received as the purchase data 114 or as other forms of data. In various embodiments, the purchase request can include and/or can be included with data that identifies an item associated with the purchase request. As noted above, the “item” can include goods and services, so the item can correspond to a service, the purchase of which is desired. Thus, operation 208 can include analyzing and/or parsing a purchase request and/or purchase data 114 to extract, determine, and/or identify a good or service associated with the purchase request.

Similarly, search constraints associated with the purchase request can be included with a purchase request and/or can be a part of the purchase request. The search constraints can include various data as illustrated and described herein including, but not limited to, a purchase date; a maximum price the purchaser is willing to pay for the good or service; a price allowance or threshold, which can be defined as a percentage or dollar amount; a maximum shipping cost the purchaser is willing to pay; a processing time for which the purchaser is willing to wait; a shipping time for which the purchaser is willing to wait; one or more vendors from which the purchaser is willing to purchase the item; a preferred vendor from which the purchaser prefers to purchase the item; a subscription indicator and/or subscription schedule; a device or item that has generated the purchase request; an indicator relating if coupons or other discounts are to be searched for and/or various access codes or logins associate with discount sites or services; specific vendors from which the purchaser is unwilling to purchase the item; weights or ranks for various preferences or parameters, which can be used to weight or rank purchase options; combinations thereof; or the like. As noted above, these and other search constraints can be included with, identified in, determined from, and/or extracted from the purchase request. As such, operation 208 can include analyzing and/or extracting these and/or other data from the purchase request. Because other information can be included as search constraints, it should be understood that the above-provided examples are illustrative and therefore should not be construed as being limiting in any way.

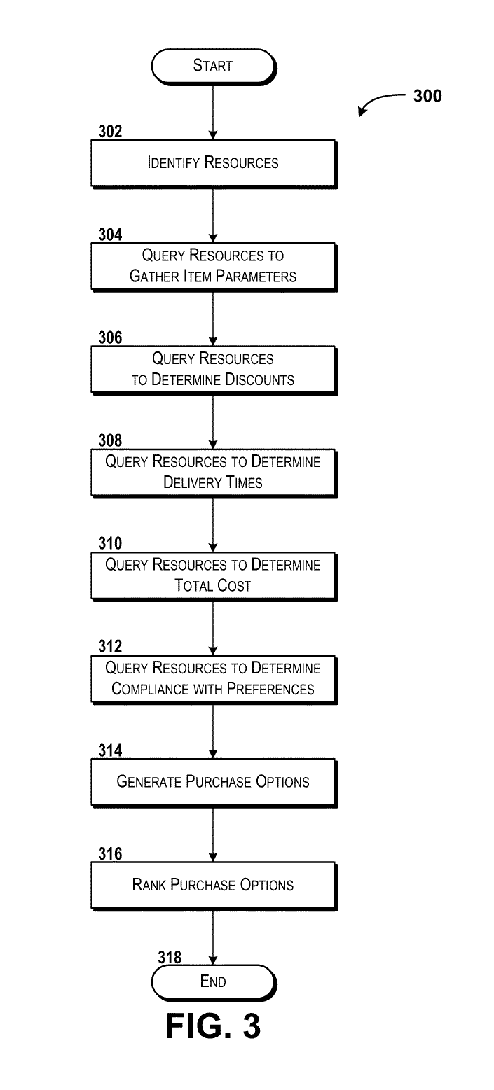

From operation 208, the method 200 proceeds to operation 210. At operation 210, the server computer 112 can calculate and rank one or more purchase options. The functionality of the server computer 112 for calculating and ranking one or more purchase options will be illustrated and described in more detail with reference to FIG. 3 below, and therefore is not described in detail here with reference to FIG. 2. Briefly, it can be appreciated that the server computer 112 can identify and communicate with one or more resources 120 to determine various options for purchasing a good or service identified in the purchase request received in operation 202. The server computer 112 also can rank the purchase options and return these purchase options to a requestor or other entity. Additional details will be provided with reference to FIG. 3 below.

From operation 210, the method 200 proceeds to operation 212. At operation 212, the server computer 112 can determine if a purchase is to be completed. Although not separately illustrated in FIG. 2, the server computer 112 can provide the ranked purchase options calculated in operation 210 to a requestor, user, the computing device 102, or other entity and receive a choice of a particular purchase option from the entity. Alternatively, the server computer 112 may receive an indication that a purchase is not to be completed. For example, the entity to whom or which the purchase options are provided may determine that the purchase options are not appropriate or desirable for various reasons, and therefore may cancel the purchase or request additional purchase options, a follow-up purchase option determination process, or the like. The purchase options can be presented in a user interface, a report, or other representation, as will be illustrated and described below, particularly with reference to FIGS. 4D-4E. Similarly, a choice of a particular purchase option or cancellation of the purchase can be received via the user interface, report, or other representation, as will be illustrated and described below.

Some embodiments of the concepts and technologies described herein also can be used to generate the purchase options for various options that may not be part of a purchase request. Thus, operation 212 can correspond to determining if the purchase options are being generated outside of an actual purchase request. It should be understood that this example is illustrative and therefore should not be construed as being limiting in any way.

If the server computer 112 determines, in operation 212, that a purchase is to be completed, the method 200 can proceed to operation 214. At operation 214, the server computer 112 can determine if billing data is stored by and/or available to the server computer 112. According to various embodiments, the purchase optimization data 116 can include user accounts, billing information, links to other account or billing information, combinations thereof, or the like. In some embodiments, the purchasing optimization service 110 can communicate with a communications network provider to bill purchases or services to a communications account that corresponds to a user or other entity associated with the purchase request. Operation 212 also can include the purchasing optimization service 110 determining if billing data, if stored, is current and/or valid. Furthermore, although not shown separately in FIG. 2, operation 212 can include identifying multiple versions of billing data for a requestor, providing multiple payment options to a user or other entity, and receiving selection of one or more payment options from the entity.

For example, the computing device 102 may generate the purchase request. Upon determination, at the purchasing optimization service 110, that a good or service is to be purchased using the purchasing optimization service 110, the purchasing optimization service 110 can communicate with a billing or charging server of a service provider that serves the computing device 102 and generate a charging or billing action. Thus, users may not be required to enter billing information when purchasing goods or services using the purchasing optimization service 110. In one particular embodiments, a user or other entity can select an option to link an account with the purchasing optimization service 110 to a billing or charging account associated with a service provider such as a wireless service provider (such as AT&T, Verizon, T-Mobile, Sprint, or the like), a television service provider (such as AT&T, Comcast, Charter, Time Warner, or the like), an Internet service provider (such as AT&T, Comcast, Charter, Time Warner, Google, or the like), or other service provider. Thus, users or other entities can define how and where goods and services purchased using the purchasing optimization service 110 are billed and/or charged.

As such, operation 214 can correspond to the purchasing optimization service 110 querying or searching the purchase optimization data 116 or other information to determine if billing data for the requestor is linked, stored, or otherwise accessible to the purchasing optimization service 110. Because the purchasing optimization service 110 can determine if billing data is stored in additional and/or alternative ways, it should be understood that this example is illustrative and therefore should not be construed as being limiting in any way.

If the server computer 112 determines, in operation 214, that billing data is not stored by and/or available to the server computer 112, the method 200 can proceed to operation 216. The method 200 also can proceed to operation 216 if the server computer 112 determines, in operation 212, that a purchase is not to be completed. At operation 216, the server computer 112 can add a purchase option to a report that is to be provided to a requestor. Thus, the purchasing optimization service 110 can generate output that reflects the purchase option (or more than one purchase option), without generating a purchase.

Thus, if billing data is not stored, expired, invalid, or otherwise unavailable to complete the purchase, if the requestor indicates that the purchase is not be completed at the time, and/or if the “purchase request corresponds to a request for a report (without an actual purchase), the purchasing optimization service 110 can generate output such as a report that saves the purchase option for future use. In some embodiments, the purchasing optimization service 110 can charge for the report to prevent requestors from obtaining purchase options without paying for the calculation and/or ranking of the purchase options. Because the report can be generated at additional and/or alternative times, it should be understood that this example is illustrative and therefore should not be construed as being limiting in any way. Furthermore, it should be understood that in some embodiments, the method 200 can end instead of proceeding to operation 216 from operations 212 and 214 as illustrated and described in FIG. 2.

If the server computer 112 determines, in operation 214, that billing data is stored by and/or available to the server computer 112, the method 200 can proceed to operation 218. At operation 218, the server computer 112 can complete the purchase using the billing data determined to be stored at operation 214. In some embodiments, as noted above, more than one payment option can be used to pay for a good or service purchased using the purchasing optimization service 110. For example, rewards points and a credit card can be used to make a purchase. Alternatively, one or more credit cards; one or more billing accounts for service providers; one or more funds transfers; one or more debit accounts; and/or other payment options and/or combinations of payment options can be used to purchase a good or service using the purchasing optimization service 110. As such, operation 218 can include multiple financial and/or account transactions.

From operation 218, the method 200 proceeds to operation 220. The method 200 also can proceed to operation 220 from operation 216. At operation 220, the server computer 112 can provide purchase data 114 to the requestor. The purchase data 114 can include, for example, a report or other output such as that generated in operation 216; a report, receipt, or other purchase confirmation; a statement or invoice for the purchase and/or for the service provided by the purchasing optimization service 110; other types of output; and/or combinations thereof. In some embodiments, a report or other output can be periodically generated by the purchasing optimization service 110 and/or can be generated each time a purchase is successful or unsuccessful, and provided to a user or other entity. One illustrative embodiment of a report will be illustrated and described below with reference to FIG. 4D. Because other types of output can be provided by the server computer 112, it should be understood that the example shown in FIG. 4D and the examples listed above are illustrative and therefore should not be construed as being limiting in any way.

In some embodiments of the concepts and technologies described herein, information collected and/or generated by the server computer 112 can be output for analytics or other uses. For example, the purchase information generated by the server computer 112 can be output for analysis to determine ratings for shopping sites, vendors, and/or particular items; to determine customer behavior history such as identifying items or services purchased, sites or vendors used, coupon information, shipping preferences and/or costs, how shipping affects purchases, or the like; customer (specific and as a group) preferences and weightings used when weighting purchase options, which may be useful for predicting future behavior and aggregation for discovery of items or services that may be popular with users; trend detection regarding behavioral data and other demographics for purposes of categorization and prediction of behavior; to determine location-relevant aspects of purchases such as determining where users complete Internet shopping; combinations thereof or the like. Because the data generated by the server computer 112 can be used for additional and/or alternative purposes, it should be understood that these examples are illustrative and therefore should not be construed as being limiting in any way.

From operation 220, the method 200 proceeds to operation 222. The method 200 ends at operation 222.

Turning now to FIG. 3, aspects of a method 300 for calculating and ranking purchase options using a purchase optimization service 110 will be described in detail, according to an illustrative embodiment. It can be appreciated with reference to FIG. 2 that the method 300 illustrated and described herein can correspond to operation 210 of the method 200, though this is not necessarily the case. It also can be appreciated from the above description that the method 300 shown in FIG. 3 can be performed to gather purchase options, and not necessarily as part of a purchase process. As such, the embodiments shown in FIGS. 2 and 3 should not be construed as being limiting in any way with regard to the functionality described herein and when and/or how such functionality can be used or provided.

The method 300 begins at operation 302. At operation 302, the server computer 112 can identify resources 120. The resources 120 identified in operation 302 can correspond to resources 120 that the server computer 112 can determine are to be queried based upon the purchase request received in operation 202 and/or based upon the search constraints identified in operation 208. In some embodiments, for example, if the purchase request corresponds to a request for a good or service X, operation 302 can correspond to the server computer 112 identifying one or more resources 120 that sell X, that offer coupons or other discounts for X, resources 120 that provide ratings or reviews of X and/or vendors that sell or provide X, combinations thereof, or the like. In some embodiments, the resources 120 identified in operation 302 also can be identified in other ways, for example by a report request if the method 300 is executed outside of a purchase scenario as explained above. Operation 302 can correspond to the server computer 112 conducting various web searches, searching databases and/or repositories, queries and/or searches of the purchase optimization data 116, combinations thereof, or the like.

From operation 302, the method 300 proceeds to operation 304. At operation 304, the server computer 112 can query some or all of the resources 120 identified in operation 302 to gather item parameters. The item parameters can include various item or service data or descriptors. In the case of items or goods, the item parameters can include, but are not limited to, data indicating if the item is used or new, a condition associated with the item, a cost of the item, a shipping time for the item, a processing time for the item, a currency accepted by vendors for the item (in case conversion is needed to compare purchase options), a vendor identifier, ratings for the item, rankings for the item, reviews for the item, combinations thereof, or the like. In the case of a service, the item parameters can include, but are not limited to, a location of the service provider, a cost of the service, a delivery time for the service, a currency accepted by vendors for the service, a vendor identifier, ratings for the vendor or service, rankings for the vendor or service, reviews for the vendor or service, combinations thereof, or the like. Because additional and/or alternative item parameters can be obtained for goods and services in operation 304, it should be understood that these examples are illustrative and therefore should not be construed as being limiting in any way.

From operation 304, the method 300 proceeds to operation 306. At operation 306, the server computer 112 can query some or all of the resources 120 identified in operation 302 to determine discounts available for purchasing a good or service from a particular vendor. Because some of the resources 120 identified in operation 302 can provide discounts or coupons for the item being purchased, operation 306 can correspond to the server computer 112 identifying resources 120 that offer coupons or other discounts and querying these resources 120 for coupons or other discounts. Based upon responses to the queries generated by the server computer 112 in operation 306, the server computer 112 can determine available coupons or other discounts to determine total cost for particular vendors, as will be explained in more detail below.

From operation 306, the method 300 proceeds to operation 308. At operation 308, the server computer 112 can query some or all of the resources 120 identified in operation 302 to determine delivery times associating with purchasing a good or service from a particular vendor. Thus, the server computer 112 can query the one or more resources 120 to determine processing times and/or shipping times for items, or delivery times for services. It should be understood that in some embodiments, processing times, shipping times, and/or delivery times can be determined by the server computer 112 in operation 304, and as such, operation 308 can be omitted in some embodiments.

From operation 308, the method 300 proceeds to operation 310. At operation 310, the server computer 112 can query some or all of the resources 120 identified in operation 302 to determine total costs associated with purchasing a good or service from a particular vendor. Thus, the server computer 112 can query the one or more resources 120 to determine shipping costs, account creation or membership costs (if applicable), item or service costs, taxes and/or duty due, other costs, combinations thereof, or the like, for the goods or services. It should be understood that in some embodiments, shipping costs, tax or duty costs, account or membership costs, item or service costs, and/or other costs can be determined by the server computer 112 in operation 304, and as such, operation 310 can be omitted in some embodiments.

From operation 310, the method 300 proceeds to operation 312. At operation 312, the server computer 112 can query some or all of the resources 120 identified in operation 302 to determine compliance of one or more vendors with preferences associated with a purchaser or requestor. In operation 312, the server computer 112 can compare rankings, reviews, costs, processing times, shipping times, other costs, or the like to the various parameters determined by the server computer 112 and/or included in the purchase request as explained herein. It should be understood that in some embodiments, rankings, reviews, costs, processing times, shipping times, other costs, or the like can be determined by the server computer 112 in operation 304, and as such, operation 312 can be omitted in some embodiments, or can correspond to merely comparing the rankings, reviews, costs, processing times, shipping times, other costs, or the like to the purchase request or various parameters as explained above.

From operation 312, the method 300 proceeds to operation 314. At operation 314, the server computer 112 can generate one or more purchase options for purchasing a good or service. In operation 314, the server computer 112 can identify one or more vendors that sell the good or service and determine a total cost, total shipping time, vendor rating, and/or other information associated with purchasing the good or service form the vendor. These data can be compiled into a “purchase option.” Thus, a purchase option can provide a vendor, a total cost, a total time to delivery, ratings or reviews, and other information so a user or other entity (including hardware and/or software) can select an optimal purchase option.

In some embodiments, the server computer 112 can be configured to generate a particular number of purchase options. In particular, in some embodiments the server computer 112 can be configured to generate up to five, ten, fifty, one hundred, one thousand, or more purchase options. In some embodiments, the server computer 112 can be configured to generate as many purchase options as are available. It can be appreciated that for some items, the total number of purchase options can be a large number. As such, some embodiments of the concepts and technologies described herein impose limits on the number of purchase options generated in operation 314. In some other embodiments, the server computer 112 can determine all available purchase options so the server computer 112 can select an optimal purchase option. Regardless of the number of purchase options being generated, the server computer 112 can generate the purchase options in operation 314.

From operation 314, the method 300 proceeds to operation 316. At operation 316, the server computer 112 can rank the purchase options generated in operation 314. According to various embodiments, the purchase options determined in operation 314 can be ranked based upon global and/or purchase-specific preferences associated with the requestor and/or the purchasing optimization service 110. For example, if a requestor specifies that delivery time is to be prioritized over price and vendor, then a first purchase option with a first delivery time that is shorter than a second delivery time associated with a second purchase option may be ranked higher than the second purchase option, regardless of the vendor and/or price.

Regardless of how the purchase options are ranked, the server computer 112 can output the ranked purchase options with data that identifies the associated ranks. It can be appreciated that there are almost endless options for ranking the purchase options, as will be more clearly understood with reference to FIGS. 4A-4E. As such, the above examples should be understood as being illustrative and should not be construed as being limiting in any way. It should be understood that various embodiments of the concepts and technologies described herein output only some purchase options. Thus, for example, the top three, five, ten, twenty, fifty, one hundred, or other number of purchase options can be output, if desired. It should be understood that this example is illustrative and therefore should not be construed as being limiting in any way.

From operation 316, the method 300 proceeds to operation 318. The method 300 ends at operation 318. It can be appreciated that after execution of the method 300, the server computer can proceed with execution of the method 200 at operation 212 as explained above, in some embodiments. It should be understood that this example is illustrative and therefore should not be construed as being limiting in any way.

FIGS. 4A-4E are user interface (“UI”) diagrams showing aspects of UIs for controlling and/or interacting with a purchase optimization service 110, according to some illustrative embodiments. FIG. 4A shows an illustrative screen display 400A, which can be generated by a device such as the computing device 102. According to various embodiments, the computing device 102 can generate the screen display 400A and/or other screen displays in conjunction with and/or based upon activation of the purchasing application 108 and/or interactions with the purchasing optimization service 110 described herein. It should be appreciated that the UI diagram illustrated in FIG. 4A is illustrative of one contemplated example of the UIs that can be generated and/or displayed in accordance with the concepts and technologies disclosed herein, and therefore should not be construed as being limited in any way.

It should be appreciated that the screen display 400A can be presented, for example, in response to detecting selection of an option to manage options or settings for the purchasing application 108 and/or the purchasing optimization service 110, in response to a first execution of or interaction with the purchasing application 108 and/or the purchasing optimization service 110, other triggers or events, combinations thereof, or the like. Because the screen display 400A illustrated in FIG. 4A can be displayed at additional and/or alternative times, it should be understood that this example is illustrative and therefore should not be construed as being limiting in any way.

The screen display 400A can include various menus and/or menu options (not shown in FIG. 4A). The screen display 400A also can include a purchasing optimization service options display (“options display 402”). The options display 402 can be configured to allow a user or other entity to control various service options, illustrative examples of which are shown in FIG. 4A. As shown in FIG. 4A, the options display 402 can include a number of importance factors 404A-H (hereinafter collectively and/or generically referred to as “importance factors 404”). Each of the importance factors 404 can have a corresponding importance factor value field 406A-H (hereinafter collectively and/or generically referred to as “importance factor value fields 406”).

A user or other entity can interact with the importance factor value fields 406 to specify a relative or absolute importance value for the corresponding importance factors 404. In the illustrated embodiment, the importance values can be specified using numerical values within a range of one and ten. It should be understood that this example is illustrative and therefore should not be construed as being limiting in any way. In particular, other relative and/or absolute ranking schemes can be used to specify a letter grade, relative weights, star scores, combinations thereof, or the like. In another contemplated embodiment, percentages can be assigned to the importance factors 404 to provide relative weights that can be controlled (e.g., by requiring that the total adds to 100%, for example). Because various absolute and/or relative ranking schemes are possible and are contemplated, it should be understood that the above-mentioned ranking values and scales are illustrative and therefore should not be construed as being limiting in any way.

In the illustrated embodiment, the importance factor value field 406A can be used to set an importance value or factor for item price for goods or services that are being purchased using a purchase request; the importance factor value field 406B can be used to set an importance value or factor for shipping cost for the goods or services that are being purchased using a purchase request; the importance factor value field 406C can be used to set an importance value or factor for shipping time for the goods or services that are being purchased using a purchase request; the importance factor value field 406D can be used to set an importance value or factor for a vendor or store rating for the goods or services that are being purchased using a purchase request; the importance factor value field 406E can be used to set an importance value or factor for whether coupons are available for the goods or services that are being purchased using a purchase request; the importance factor value field 406F can be used to set an importance value or factor for using a particular preferred vendor for the goods or services that are being purchased using a purchase request; the importance factor value field 406G can be used to set an importance value or factor for a delivery time for the goods or services that are being purchased using a purchase request; and the importance factor value field 406H can be used to set an importance value or factor for a total cost for the goods or services that are being purchased using a purchase request. Because additional and/or alternative importance factor fields 406 can be included in the purchase request and options display 402, it should be understood that these examples are illustrative and therefore should not be construed as being limiting in any way.

The options display 402 also can be configured to allow a user or other entity to control various general purchase options, some illustrative examples of which are shown in FIG. 4A. In particular, as shown in FIG. 4A, the options display 402 can include a number of general purchase option settings 408A-G (hereinafter collectively and/or generically referred to as “general purchase option settings 408”). Each of the general purchase option settings 408 can have a corresponding UI control 410A-G (hereinafter collectively and/or generically referred to as “UI controls 410”).

A user or other entity can interact with the UI controls 410 to specify a binary yes/no, true/false, activated/inactivated, or other indicator for a corresponding general purchase option setting 408. In some embodiments, the binary setting can be replaced with or supplemented by a multi-faceted response field, for example a drop down list that can include two or more choices. For example, the “Use Store Points” general purchase option setting 108 can have a dropdown list of settings instead of the illustrated UI control 410A. The dropdown list or other control can include settings of “Always,” “Never,” or other options such as threshold amounts where the always or never settings apply, or other options. Thus, while in the illustrated embodiment, the UI controls 410 can provide a binary setting for selection by the user or other entity, it should be understood that this example is illustrative and therefore should not be construed as being limiting in any way.

In the illustrated embodiment, the UI control 410A can be used to activate or deactivate an option to use store points for goods or services that are being purchased using a purchase request; the UI control 410B can be used to activate or deactivate an option to search for coupons for the goods or services that are being purchased using a purchase request; the UI control 410C can be used to activate or deactivate an option to choose the vendor that offers the cheapest shipping for the goods or services that are being purchased using a purchase request; the UI control 410D can be used to activate or deactivate an option to allow purchases of used goods that are being purchased using a purchase request; and the UI controls 410E-G can be used to activate or deactivate an option to consider a particular vendor for the goods or services that are being purchased using a purchase request. Because additional and/or alternative UI controls 410 can be included in the purchase request and options display 402, it should be understood that these examples are illustrative and therefore should not be construed as being limiting in any way.

Referring now to FIG. 4B, a UI diagram showing additional aspects of the concepts and technologies disclosed herein for providing a purchase optimization service 110 is described in detail. In particular, FIG. 4B shows an illustrative screen display 400B, which can be generated by a device such as the computing device 102. It should be appreciated that the UI diagram illustrated in FIG. 4B is illustrative of one contemplated example of the UIs that can be generated and/or displayed in accordance with the concepts and technologies disclosed herein, and therefore should not be construed as being limited in any way.

The screen display 400B can include a purchase request and option display 412. The purchase request and option display 412 can be used to create a purchase request, as well as to set purchase-specific preferences to be communicated to and/or used by the purchase optimization service 110 as disclosed herein. It can be appreciated that the purchase request and option display 412 can be presented in response to a user selecting an option to purchase an item from within a purchasing application 108, by interacting with the purchasing optimization service 110, by selecting a UI control to purchase a good or service, and/or via other interactions with the computing device 102. Because the purchase request and option display 412 can be displayed at additional and/or alternative times, it should be understood that these examples are illustrative, and should not be construed as being limiting in any way.

The purchase request and option display 412 can include an indicator or depiction (“indicator”) 414 of a good or service that is to be purchased. In the illustrated embodiment, the indicator 414 includes a product thumbnail. Because the functionality of the purchasing optimization service 110 and/or purchasing application 108 can be used to purchase a good or service, it should be understood that the illustrated embodiment is illustrative and should not be construed as being limiting in any way.

A UI control 416 for editing or changing the good or service associated with the purchase request and option display 412 can be included in some embodiments. Upon selection of the UI control 416, the computing device 102 can provide an interface (e.g., a browser window, search field, or the like) to enable searching for other goods or services. It should be understood that this example is illustrative and therefore should not be construed as being limiting in any way.

The purchase request and option display 412 can also include various purchase parameters 418A-E (hereinafter collectively and/or generically referred to as “purchase parameters 418”). The purchase request and option display 412 can also include one or more purchase parameter fields 420A-E (hereinafter collectively and/or generically referred to as “purchase parameter fields 420”). The purchase parameter fields 420 can be interacted with to adjust and/or set corresponding purchase parameters 418. Thus, for example, a user or other entity can enter data in the purchase parameter field 420A to set a quantity of goods or services to be purchased. It should be understood that this example is illustrative and therefore should not be construed as being limiting in any way.

In the illustrated embodiment, the purchase parameter field 420A can be used to set a quantity of goods or services that are being purchased using a purchase request; the purchase parameter field 420B can be used to set a maximum total price the user or other entity is willing to pay for the goods or services that are being purchased using a purchase request; the purchase parameter field 420C can be used to set a maximum shipping cost the user or other entity is willing to pay for the goods that are being purchased using a purchase request; the purchase parameter field 420D can be used to set a maximum shipping time the user or other entity is willing to wait for the goods that are being purchased using a purchase request; and the purchase parameter field 420E can be used to specify a preferred vendor for the goods or services that are being purchased using a purchase request. Because additional and/or alternative the purchase parameter fields 420 can be included in the purchase request and option display 412, it should be understood that these examples are illustrative and therefore should not be construed as being limiting in any way.

The purchase request and option display 412 also can include UI control 422. The UI control 422 can be used to enable or disable the use of purchase-specific preferences or options. Upon selection of a true, yes, enable, activate, or similar option using the UI control 422, the purchase request and option display 412 can be modified to display one or more purchase-specific options 424A-F (hereinafter collectively and/or generically referred to as “purchase specific options 424”) and associated purchase-specific option controls 426A-F (hereinafter collectively and/or generically referred to as “purchase-specific option controls 426”). Similarly, upon selection of a false, no, disable, deactivate, or similar option using the UI control 422, the purchase request and option display 412 can be modified to hide the purchase-specific options 424 and purchase-specific option controls 426, if desired. It should be understood that this example is illustrative and therefore should not be construed as being limiting in any way.

In the illustrated embodiment, the purchase-specific option control 426A can be used to set whether or not the goods that are being purchased using a purchase request can be purchased used; the purchase-specific option control 426B can be used to set whether or not the goods or services that are being purchased using a purchase request can be purchased from a particular vendor such as Craigslist; the purchase-specific option control 426C can be used to set whether or not the goods that are being purchased using a purchase request can be purchased from a particular vendor such as ebay; the purchase-specific option control 426D can be used to set whether or not the goods that are being purchased using a purchase request can be purchased from a particular vendor such as Etsy; the purchase-specific option control 426E can be used to set whether or not the goods or services that are being purchased using a purchase request can be purchased from other specialty sites; and the purchase-specific option control 426F can be used to set whether or not a subscription should be created for periodically purchasing the goods or services that are being purchased using a purchase request. Because additional and/or alternative the purchase-specific option controls 426 can be included in the purchase request and option display 412, it should be understood that these examples are illustrative and therefore should not be construed as being limiting in any way.

Referring now to FIG. 4C, a UI diagram showing additional aspects of the concepts and technologies disclosed herein for providing a purchase optimization service 110 is described in detail. In particular, FIG. 4C shows an illustrative screen display 400C, which can be generated by a device such as the computing device 102. It should be appreciated that the UI diagram illustrated in FIG. 4C is illustrative of one contemplated example of the UIs that can be generated and/or displayed in accordance with the concepts and technologies disclosed herein, and therefore should not be construed as being limited in any way.

The screen display 400C can include a subscription options display 430. The subscription options display 430 can be presented, for example, in response to a user or other entity selecting or otherwise manipulating the purchase-specific option control 426F shown in FIG. 4B. Because the subscription options display 430 can be displayed at additional and/or alternative times and/or in response to other manipulations and/or interactions with the computing device 102, it should be understood that this embodiment is illustrative, and should not be construed as being limiting in any way.

The subscription options display 430 also can include one or more subscription options 432A-F (hereinafter collectively and/or generically referred to as “subscription options 432”) and associated subscription option controls 434A-F (hereinafter collectively and/or generically referred to as “subscription option controls 434”). In the illustrated embodiment, the subscription option control 434A can be used to set whether or not the goods or services that are being purchased using a purchase request can be purchased using store points or rewards programs; the subscription option control 434B can be used to set whether or not a search for coupons is to be conducted prior to purchasing the goods or services that are being purchased using a purchase request; the subscription option control 434C can be used to set whether or not the goods that are being purchased using a purchase request are to be purchased from a particular vendor that has the cheapest shipping costs; the subscription option control 434D can be used to set whether or not the goods or services that are being purchased using a purchase request can be purchased from alternative vendors; the subscription option control 434E can be used to set a percentage over the maximum price that is to be allowed when purchasing goods or services that are being purchased using a purchase request; and the subscription option control 434F can be used to set a dollar amount over the maximum price that is to be allowed when purchasing goods or services that are being purchased using a purchase request. Because additional and/or alternative the subscription option controls 434 can be included in the subscription options display 430, it should be understood that these examples are illustrative and therefore should not be construed as being limiting in any way.

The subscription options display 430 also can include a UI control 436 for saving changes to a subscription as defined using the subscription options display 430. Upon selection of the UI control 436, the computing device 102 can submit the subscription options defined using the subscription options display 430 and/or other options or preferences to the purchasing optimization service 110. Because the subscription options can be submitted to the purchasing optimization service 110 at additional and/or alternative times and/or in response to other manipulations and/or interactions with the computing device 102, it should be understood that this embodiment is illustrative, and should not be construed as being limiting in any way.

The subscription options display 430 also can include a UI control 438. The UI control 438 can be used to cancel a subscription. Thus, for example, a user or other entity can delete a subscription by selecting the UI control 438. The subscription options display 430 also can include a UI control 440, which can be used skip a next delivery of a subscription. Thus, for example, a user or other entity can skip a delivery of a subscription without cancelling or deleting the subscription by selecting the UI control 440. Upon selection of the UI controls 438 or 440, the computing device 102 can submit data indicating the cancellation and/or delay associated with the subscription to the purchasing optimization service 110. Because these and other data can be submitted to the purchasing optimization service 110 at additional times, at alternative times, and/or in response to other manipulations and/or interactions with the computing device 102, it should be understood that this embodiment is illustrative, and should not be construed as being limiting in any way.

Referring now to FIG. 4D, a UI diagram showing additional aspects of the concepts and technologies disclosed herein for providing a purchase optimization service 110 are described in detail. In particular, FIG. 4D shows an illustrative screen display 400D generated by a device such as the computing device 102. It should be appreciated that the UI diagram illustrated in FIG. 4D is illustrative of one contemplated example of the UIs that can be generated and/or displayed in accordance with the concepts and technologies disclosed herein, and therefore should not be construed as being limited in any way.

The screen display 400D can include a report 442. The report 442 can be presented in response to a user or other entity requesting the report 442 from the purchasing optimization service 110, in response to the purchasing optimization service 110 sending the report 442 to the computing device 102, by selecting or otherwise manipulating a UI control for requesting and/or presenting the report 442, and/or in response to other triggers, events, and/or input. Because the report 442 can be displayed at additional and/or alternative times, it should be understood that this embodiment is illustrative, and should not be construed as being limiting in any way.

The report 442 can include details about purchases and/or subscriptions made (or to be made) using the purchasing optimization service 110, or purchase options available for a particular good or service if the report 442 is requested outside of a purchase scenario. The report 442 can show purchases, dates of purchases, quantities, prices paid, amounts over (if any), vendor information, purchase result (successful, cancelled, backordered, etc.), if the purchase is part of a subscription, and remarks, if desired and/or if appropriate. If not purchases have been completed or are schedule, these values can be blank or otherwise can indicate that no purchases have occurred or are scheduled.

Additional and/or alternative information can be conveyed by the report 442. For example, the report 442 can include information indicating shipping and/or processing times; information indicating one or more locations associated with vendors, recipients, and/or payors; information indicating accounts and/or payment methods used to pay for purchases; combinations thereof; or the like. Because the reports 442 can include additional and/or alternative information, it should be understood that the screen display 400D shown in FIG. 4D is illustrative and should not be construed as being limiting in any way.

In the example report 442 shown in FIG. 4D, the paper towels purchase from Sep. 12, 2015 includes remarks. The remarks indicate that the purchase was cancelled because the maximum price (including any defined threshold or allowance over the maximum price) was exceeded by the asking price. In this embodiment, the purchasing optimization service 110 cancelled the purchase. It should be understood that this example is illustrative and therefore should not be construed as being limiting in any way.

Referring now to FIG. 4E, a UI diagram showing additional aspects of the concepts and technologies disclosed herein for providing a purchase optimization service 110 is described in detail. In particular, FIG. 4E shows an illustrative screen display 400E, which can be generated by a device such as the computing device 102. It should be appreciated that the UI diagram illustrated in FIG. 4E is illustrative of one contemplated example of the UIs that can be generated and/or displayed in accordance with the concepts and technologies disclosed herein, and therefore should not be construed as being limited in any way.

The screen display 400E can include a purchase options display 450. The purchase options display 450 can be presented, for example, in response to a user or other entity submitting a purchase request, in response to the purchasing optimization service 110 searching for purchase options in response to a request or based upon a subscription or reorder policy, in response to a request to view purchase options, and/or based upon other transactions or triggers. Because the purchase options display 450 can be displayed at additional and/or alternative times and/or in response to other manipulations and/or interactions with the computing device 102, it should be understood that this embodiment is illustrative, and should not be construed as being limiting in any way.

The purchase options display 450 can include one or more purchase options 452A-C (hereinafter collectively and/or generically referred to as “purchase options 452”). In the illustrated embodiment, the purchase options 452 can provide a total price and an indication of whether or not the total price includes any coupons, tax, or the other charges; a delivery time, which can include processing and shipping time, as well as an indication of a shipping charge; and a vendor identifier. It can be appreciated from the above description that various other information can be included in the purchase options 452 such as, for example, vendor ratings, reviews, locations, purchase history (of the requestor with the vendor), promotions or offers, alternative products or services that may be of interest to the requestor, combinations thereof, or the like. As such, the illustrated embodiment should be understood as illustrative and therefore should not be construed as being limiting in any way.

In the illustrated embodiment, the purchase option 452A is shown as being highlighted to indicate that a user has selected the purchase option 452A. It should be understood that this example is illustrative and therefore should not be construed as being limiting in any way. The purchase options display 450 also can include a UI control 454 for obtaining or viewing additional purchase options 452. It should be understood that in some embodiments, the purchase options display 450 can be scrollable or otherwise manipulated to view additional or alternative purchase options 452.

The purchase options display 450 also can include a UI control 456 for purchasing a good or service in accordance with the selected purchase option 452. In the illustrated embodiment, a user or other entity is selecting the UI control 456 to purchase the good or service in accordance with the purchase option 452A. It should be understood that this example is illustrative and therefore should not be construed as being limiting in any way. In response to selection of the UI control 456, the computing device 102 or other device can send the purchase request to the purchasing optimization service 110 as described with reference to operation 204 in FIG. 2. Because additional and/or alternative actions can be taken in response to selection of the UI control 456, it should be understood that this example is illustrative and therefore should not be construed as being limiting in any way.

The purchase options display 450 also can include a UI control 458 for cancelling a purchase request. In response to selection of the UI control 458, the computing device 102 or other device can send the purchase request cancellation to the purchasing optimization service 110 as described with reference to operation 204 in FIG. 2. It can be appreciated that the screen display 400E can be generated outside of a purchase request, the UI control 458 and/or other UI controls can be used to dismiss the screen display 400E without cancelling or accepting a purchase option. Because additional and/or alternative actions can be taken in response to selection of the UI control 458, it should be understood that this example is illustrative and therefore should not be construed as being limiting in any way.

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards as well as evolved and future mobile standards.

The packet data network 504 includes various devices, for example, servers, computers, databases, and other devices in communication with another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

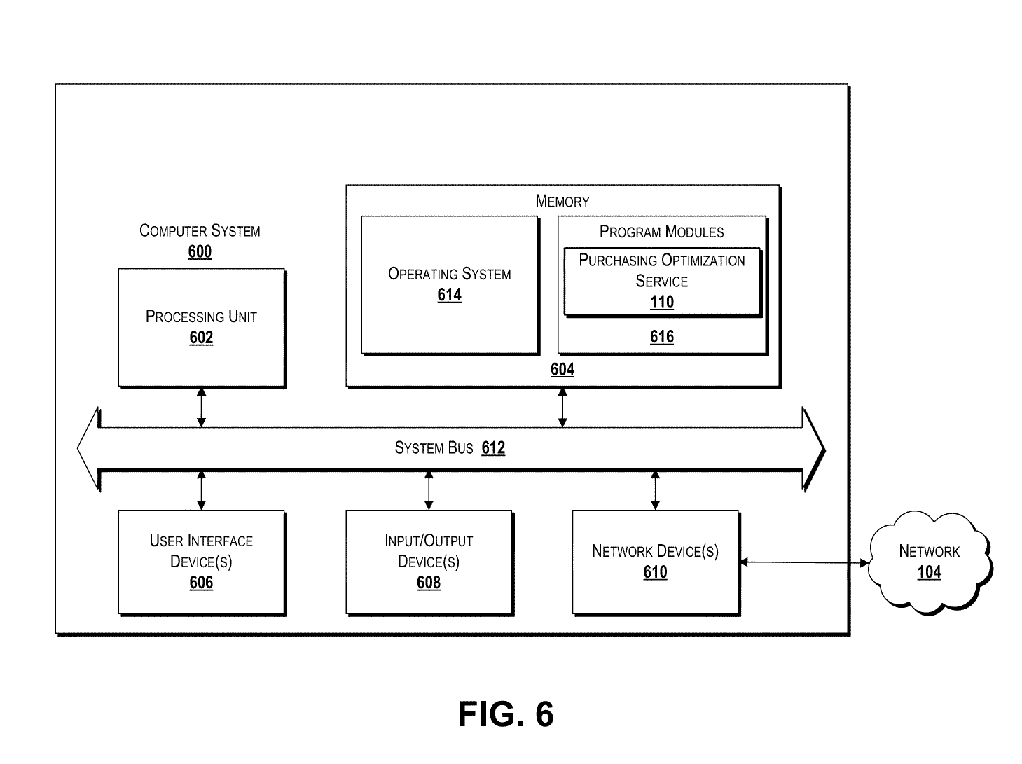

FIG. 6 is a block diagram illustrating a computer system 600 configured to provide the functionality described herein for a purchase optimization service, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the purchasing program 108 and/or the purchasing optimization service 110. This and/or other programs can be embodied in computer-readable media containing instructions that, when executed by the processing unit 602, perform one or more of the methods 200, 300 described in detail above with respect to FIGS. 2-3. According to embodiments, the program modules 616 may be embodied in hardware, software, firmware, or any combination thereof. Although not shown in FIG. 6, it should be understood that the memory 604 also can be configured to store the purchase data 114, the purchase optimization data 116, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

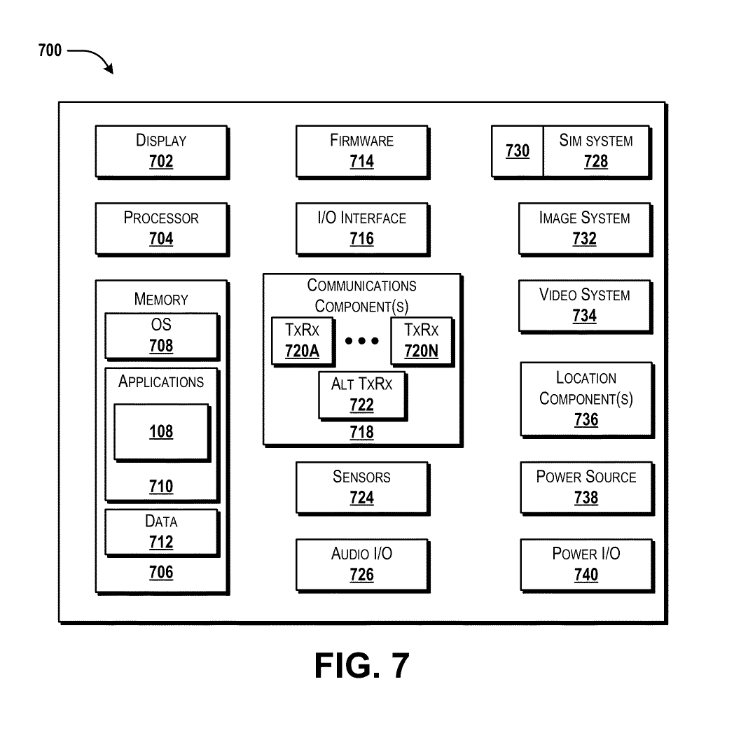

Turning now to FIG. 7, an illustrative mobile device 700 and components thereof will be described. In some embodiments, the computing device 102 described above with reference to FIGS. 1-4E can be configured as and/or can have an architecture similar or identical to the mobile device 700 described herein in FIG. 7. It should be understood, however, that the computing device 102 may or may not include the functionality described herein with reference to FIG. 7. While connections are not shown between the various components illustrated in FIG. 7, it should be understood that some, none, or all of the components illustrated in FIG. 7 can be configured to interact with one other to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements for creating purchasing requests, setting purchasing preferences (global and purchase-specific), configuring subscriptions, viewing reports such as the report 442, configuring settings, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710 such as the purchasing application 108, the purchasing optimization service 110, other computer-executable instructions stored in a memory 708, or the like. In some embodiments, the applications 706 also can include a UI application (not illustrated in FIG. 7).

The UI application can interface with the operating system 708, such as the operating system 106 shown in FIG. 1, to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, creating purchasing requests, setting purchasing preferences (global and purchase-specific), configuring subscriptions, viewing reports such as the report 442, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include, for example, the purchase data 114, the purchase optimization data 116, and/or other applications or program modules. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interfaced 716 can be configured to support the input/output of data such as location information, the queries 122, the responses 124, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ411) port, an RJ11 port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the network 104 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

Based on the foregoing, it should be appreciated that systems and methods for providing and interacting with a purchase optimization service have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

We claim:

1. A method comprising:
defining, at a processor executing a purchasing optimization service, service preferences for purchasing using the purchasing optimization service, wherein the service preferences apply to purchases made using the purchasing optimization service;
receiving, at the processor, a purchase request comprising a request to purchase an item using the purchase optimization service;
determining, at the processor, purchase preferences specific to the purchase request;
generating, by the processor, a plurality of purchase options determined based upon the service preferences, the purchase preferences, and the purchase request;
determining, at the processor, a purchase option of the plurality of purchase options; and
purchasing, by the processor, the item using the purchase option.

2. The method of claim 1, wherein determining the purchase option comprises:
providing a plurality of purchase options to a requestor associated with the purchase request; and
receiving, from the requestor, identification of the purchase request.

3. The method of claim 1, wherein determining the plurality of purchase options comprises:
identifying a plurality of vendors;
identifying, for each of the plurality of vendors, a total cost and time to delivery for the item; and
determining each of the plurality of purchase options, wherein each of the plurality of purchase options identifies a vendor, the total cost, and the time to delivery.

4. The method of claim 3, wherein determining the total cost comprises identifying a coupon available and applying a coupon.

5. The method of claim 4, wherein determining the total cost comprises determining shipping costs and identifying tax due for the purchase, and wherein determining the time to delivery comprises identifying a processing time for the vendor and determining a shipping time for the item.

6. The method of claim 1, further comprising creating a subscription for the item, wherein the optimization service determines the purchase option each time a purchase is made in accordance with the subscription.

7. The method of claim 1, further comprising generating a report, wherein the report comprises indications of purchases made using the purchasing optimization service.

8. The method of claim 1, wherein the service preferences comprise options for setting ratings for:
total price for the item;
shipping cost;
shipping time; and
availability of coupons.

9. The method of claim 1, wherein the purchase preferences comprise options for indicating:
whether buying the item used is allowed;
whether particular vendors are to be considered; and
whether a subscription for the purchase is to be created.

10. The method of claim 1, wherein receiving the purchase request comprises determining that a reorder process associated with a subscription is to be initiated.

11. The method of claim 1, wherein receiving the purchase request comprises receiving the request from a smart appliance that determines that the item should be reordered.

12. The method of claim 1, wherein the item comprises a service.

13. The method of claim 1, further comprising ranking the plurality of purchase options based upon the purchase request, the service preferences, and the purchase preferences.

14. A system comprising:
a processor; and
a memory that stores computer-executable instructions that, when executed by the processor, cause the processor to perform operations comprising
defining service preferences for purchasing using a purchasing optimization service, wherein the service preferences apply to purchases made using the purchasing optimization service,
receiving a purchase request comprising a request to purchase an item using the purchase optimization service,
determining purchase preferences specific to the purchase request,
generating a plurality of purchase options determined based upon the service preferences, the purchase preferences, and the purchase request,
determining a purchase option of the plurality of purchase options, and
purchasing the item using the purchase option.

15. The system of claim 14, further comprising computer-executable instructions that, when executed by the processor, cause the processor to perform operations further comprising:
ranking the plurality of purchase options based upon the purchase request, the service preferences, and the purchase preferences.

16. The system of claim 14, wherein ranking the plurality of purchase options comprises:
identifying, for each of the plurality of purchase options, a total cost and time to delivery for the item; and
ranking the plurality of purchase options based upon comparing the total cost and time to delivery to the service preferences and purchase preferences.

17. The system of claim 14, wherein determining the total cost comprises:
identifying a coupon available and applying the coupon to a price for the item;
subtracting a value of the coupon from the price for the item;
determining shipping costs and tax due for the purchase; and
adding the shipping cost and tax due to the price for the item.

18. The system of claim 14, further comprising computer-executable instructions that, when executed by the processor, cause the processor to perform operations further comprising:
creating a subscription for the item, wherein the optimization service determines the purchase option each time a purchase is made in accordance with the subscription.

19. A computer storage medium having computer-executable instructions stored thereon that, when executed by a processor, cause the processor to perform operations comprising:
defining service preferences for purchasing using a purchasing optimization service, wherein the service preferences apply to purchases made using the purchasing optimization service;
receiving a purchase request comprising a request to purchase an item using the purchase optimization service;
determining purchase preferences specific to the purchase request;
generating a plurality of purchase options determined based upon the service preferences, the purchase preferences, and the purchase request;
determining a purchase option of the plurality of purchase options; and
purchasing the item using the purchase option.

20. The computer storage medium of claim 19, further comprising computer-executable instructions that, when executed by the processor, cause the processor to perform operations further comprising:
ranking the plurality of purchase options based upon the purchase request, the service preferences, and the purchase preferences, wherein ranking the plurality of purchase options comprises
identifying, for each of the plurality of purchase options, a total cost and time to delivery for the item, and
ranking the plurality of purchase options based upon comparing the total cost and time to delivery to the service preferences and purchase preferences; and
creating a subscription for the item, wherein the optimization service determines the purchase option each time a purchase is made in accordance with the subscription.
